(19) United States
(12) Patent Application Publication
(10) Pub. No.: US 2007/0101944 A1
(43) Pub. Date: May 10, 2007

(54) Hand-held device for cleaning animals

(76) Inventor: Katja Gischel, Erlensee (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 11/589,691

(22) Filed: Oct. 30, 2006

(30) Foreign Application Priority Data
Nov. 9, 2005 (DE) 20 2005 017 637.0
Oct. 25, 2006 (DE) 10 2006 051 094.1

(51) Int. Cl. A01K 13/00

(52) U.S. Cl. 119/613

(57) ABSTRACT

The invention pertains to a hand-held device for cleaning animals that comprises a basic support element with a handle element, wherein cleaning and drying surfaces are provided on the basic support element. According to the invention, the basic support element is realized in the form of a body with at least two sides that face away from one another, wherein one side features the crude cleaning and drying surface and the other side features the delicate cleaning and drying surface.

The invention pertains to a hand-held device for cleaning animals, particularly dogs, according to the preamble of claim 1, as well as to a basic support element and cleaning surfaces for such a hand-held device.

A device of the initially mentioned type is known from DE 298 07 717 U1. This device comprises a basic support element with a handle element, wherein two surfaces for cleaning and drying are provided on the basic support element.

In this case, the bottom surface of the basic support element is provided with a trough-like receptacle arrangement for cleaning animal paws that this preferably penetrated by movable cleaning bristles driven by means of shaft elements and drive elements supported outside the bottom surface. The drive of these cleaning elements is preferably realized in an electromotive fashion with a pressure switch that can be actuated by the load of the animal paw placed onto the surface. The housing of the trough-like receptacle arrangement is realized such that it can be filled with a cleaning liquid, into which the cleaning bristles protrude such that they are moistened. The dirt accumulating during the cleaning of the animal paws drops into the liquid through the slots in the bottom surface of the service trough such that the formation of dust is prevented. Stacked tissues for drying the animal paws are situated in the other longitudinal chamber. A cover with a peripheral edge traverses the service trough when the device is not in use.

The disadvantages of this above-described device for cleaning animal paws can be seen in that the animals need to position themselves in the device on their own initiative or under the guidance of the person cleaning the animal, and that the animal paws need to be treated with moving bristles that are soaked with liquid. This can easily irritate animals that are easily scared. In addition, the animal paws and the adjacent extremities need to be dried manually.

Since the cleaning elements of the above-described device disclosed in DE 298 07 717 U1 are usually operated electrically, the utilization of the device is restricted while traveling, wherein said device also requires a correspondingly large storage space within the vehicle or the house as well as a longer set-up time that can cause certain animals to spread dirt and moisture over an even larger area within the residence or the vehicle.

It is also disadvantageous that the aforementioned device for cleaning animal paws apparently is primarily suitable for dog paws such that its range of applications is limited.

The invention is based on the objective of improving a device of the initially mentioned type in such a way that it has a more manageable design, can be used without an external energy supply and easily cleaned.

In a hand-held device for cleaning animals of the initially described type, this objective is attained with the characteristics disclosed in the characterizing portion of claim 1.

According to the invention, the basic support element consequently is realized in the form of a body with at least two sides that face away from one another, wherein one side features the crude cleaning and drying surface and the other side features the delicate cleaning and drying surface.

The crude cleaning of animals, preferably of their paws and adjacent extremities, is carried out with the hand-held device in such a way that one hand of the pet owner takes hold of the inventive hand-held device at the handle and the soiled areas of the animal are cleaned and dried with the crude cleaning and drying surface in the form of wiping and rubbing movements. If so required, the other hand of the pet owner fixes the adjacent extremity of the animal such that the soiled areas can be effectively cleaned and dried without annoying the animal.

The delicate cleaning and drying of the crudely cleaned and slightly dried areas of the animal is carried out by moving the far side of the inventive hand-held device back and forward, wherein this may be simply realized by reversing the handle of the hand-held device depending on the respective application. The degree of soiling of the areas to be cleaned may make it necessary to clean the hand-held device after it was used on an animal, wherein this is preferably achieved by cleaning the sides with water and subsequently wiping the sides with a rag or, alternatively, in the washer. The advantage of this invention is that the surfaces on the sides of the hand-held device for cleaning animals can be cleaned and—depending on the respective design—exchanged independently of one another.

In comparison with known glove-like solutions (see U.S. Pat. No. 4,670,930), another advantage can be seen in that the hands of the person cleaning the animal do not become moist or dirty during the cleaning of the animal because the handle element is spaced apart from the cleaning surfaces by a certain distance and is impenetrable to moisture.

Furthermore, the utilization of the basic support element with a handle element ensures that the hand size of the person cleaning the animal is irrelevant. The proper handling of the above-mentioned “glove” solution is only ensured with an average hand size, i.e., problems may arise, under certain circumstances, if such a device is used by children or men with large hands.

Although this concerns a rather subjective characteristic, the utilization of the inventive hand-held device demonstrated that animals perceive the cleaning procedure to be significantly less stressful than in instances in which the glove-like solutions are used because the cleaning procedure is carried out in a stroking rather than a kneading fashion.

Since the inventive hand-held device can also be manufactured and sold in the form of individual components, claims 11 and 12 respectively pertain to a basic support element for a hand-held device consisting of a shell-shaped body for receiving the surfaces that face away from one another and a handle element rigidly arranged on the basic support element, as well as cleaning surfaces (for example microfiber material) for a hand-held device consisting of two congruent surfaces that are connected (for example sewn) to one another in a pocket-like fashion on their edges, wherein an opening is provided for inserting the basic support element.

Other advantageous additional developments are defined in the dependent claims.

The inventive hand-held device for cleaning animals as well as advantageous additional developments thereof are described in greater detail below with reference to two embodiments that are illustrated in Figures.

The figures show

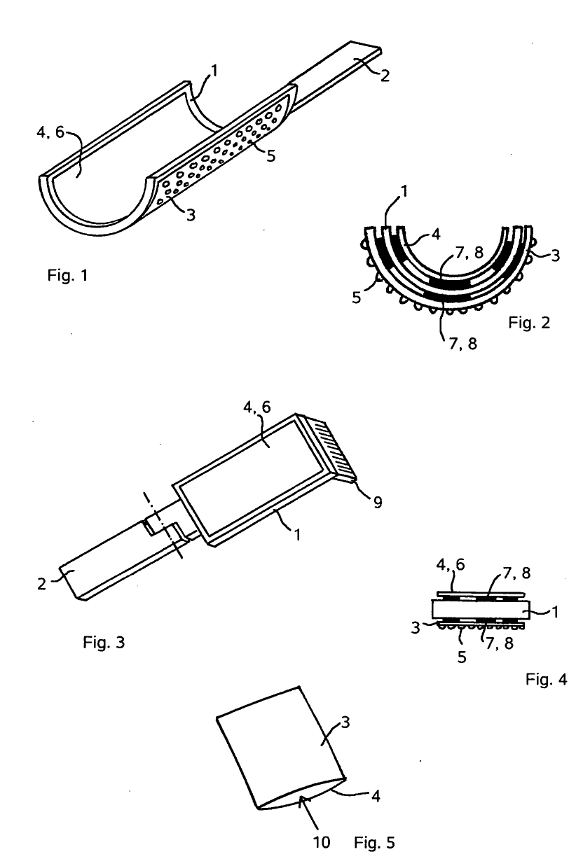

FIG. 1 a perspective representation of a first embodiment of the inventive hand-held device;

FIG. 2 a section through the basic support element according to FIG. 1;

FIG. 3 a perspective representation of another embodiment of the inventive hand-held device;

FIG. 4 a section through the basic support element according to FIG. 3; and

FIG. 5 a particularly preferred embodiment of cleaning surfaces that are realized in a pocket-like fashion and feature an opening for inserting the basic support element.

FIGS. 1 to 4 show two embodiments of the inventive hand-held device. As initially mentioned, this device consists of a basic support element 1 with a handle element 2, wherein cleaning and drying surfaces 3, 4 are provided on the basic support element 1.

Two surfaces are shown in all figures. Depending on the cross-sectional shape of the body (triangular, quadrangular, pentagonal or hexagonal, etc., or even cylindrical or the like), it is also possible that a larger number of surfaces with different or repetitive functions are provided.

An essential aspect of the inventive hand-held device (this applies to all embodiments) is that the basic support element 1 is realized in the form of a body with the least two sides that face away from one another, wherein one side features the crude cleaning and drying surface 3 and the other side features the delicate cleaning and drying surface 4.

According to FIG. 1, the basic support element 1 of this embodiment consists of a flat shell-shaped body (such as a segment of a cylinder barrel), wherein the crude cleaning and drying surface 3 is realized in a convex fashion and the delicate cleaning and drying surface 4 is realized in a concave fashion. In addition to achieving favorable ergonomics, this special shape also provides the advantage that the cleaning device practically cannot lie on a surface in a planar fashion, i.e., the cleaning device is always subjected to an air circulation that accelerates the drying process (fewer unpleasant odors). The reduced contact surface also prevents the surroundings from being soiled.

With respect to the crude cleaning of animals, particularly their paws and extremities, it is particularly advantageous to provide the convex surface 3 with nodules 5, wherein the nodules 5 are preferably realized in a sponge-like fashion.

With respect to the delicate cleaning and drying of crudely cleaned animal extremities, it is particularly advantageous to provide the concave surface 4 with textile material 6, preferably a formed fabric or microfiber material. This formed fabric 6 absorbs dirt and moisture particularly well.

According to another advantageous characteristic of the inventive hand-held device, the surfaces 3, 4 shown in Figures 2 and 4 are respectively provided with connecting means 7 on the side that faces the basic support element 1 in order to be selectively cleaned and/or exchanged. The basic support element 1 is provided with at least one fixing element 8 that cooperates with the connecting means 7 in order to receive and fix the surfaces 3, 4.

With respect to the cleaning and/or the exchange of one or both surfaces 3, 4, it is particularly advantageous to realize the connecting means 7 and the fixing element 8 in the form of a Velcro fastener. Their functional arrangement is illustrated in FIGS. 1 to 4.

Another advantageous embodiment of the hand-held device is illustrated in FIG. 3. According to this figure, the handle element 2 is hinged to the basic support element 1 and preferably can be locked in position. This characteristic simplifies the cleaning and drying in areas of the animal that are difficult to access. In this case, the storage of the device after its use requires particularly little space.

According to another advantageous characteristic of the invention, the handle element 2 is arranged on the basic support element 1 in a rigid but detachable fashion. This is particularly advantageous if the surfaces 3, 4 are significantly soiled because the hand-held device can be completely cleaned without the handle element 2 in this case.

FIG. 3 shows another advantageous embodiment of the hand-held device. In this case, the basic support element 1 is provided with a marginal bristle element 9 on the opposite side referred to the handle element 2. The marginal bristle element 9 is arranged on the surface 3 used for crude cleaning. Coarse particles and small rock-like grains can be removed with this marginal bristle element 9 of the hand-held device, particularly from the region between the animal paws.

Lastly, FIG. 5 shows a particularly preferred embodiment of the cleaning surfaces. In this case, the surfaces 3, 4 are congruently connected to one another in a pocket-like fashion, wherein the basic support element 1 can be inserted into an opening 10 (arranged on one of the four surface edges). The aforementioned connecting means 7 are arranged in the interior of the pocket-like cleaning surfaces such that they can be adapted to the preferably semi-cylindrical shape of the basic support element 1 and fixed thereon.

### LIST OF REFERENCE SYMBOLS

1 Basic support element
2 Handle element
3 (Crude cleaning and drying) surface
4 (Delicate cleaning and drying) surface
5 Nodules
6 Textile material
7 Connecting means
8 Fixing element
9 Marginal bristle element
10 Opening

1. A hand-held device for cleaning animals, comprising a basic support element with a handle element, wherein cleaning and drying surfaces are provided on the basic support element, characterized in
that the basic support element is realized in the form of a body with at least two sides that face away from one another, wherein one side features the crude cleaning and drying surface and the other side features the delicate cleaning and drying surface.

2. The hand-held device according to claim 1, characterized in
that the basic support element consists of a flat shell-shaped body, wherein the crude cleaning and drying surface is realized in a convex fashion and the delicate cleaning and drying surface is realized in a concave fashion.

3. The hand-held device according to claim 1, characterized in that one surface is provided with nodules.

4. The hand-held device according to claim 1, characterized in that the other surface is provided with textile material.

5. The hand-held device according to claim 1, characterized in that the surfaces are respectively provided with connecting means on the side that faces the basic support element in order to be selectively cleaned and/or exchanged.

6. The hand-held device according to claim 5, characterized in that the basic support element is provided with at least one fixing element that cooperates with the connecting means in order to receive and fix the surfaces.

7. The hand-held device according to claim 6, characterized in that the connecting means and the fixing element are realized in the form of a Velcro fastener.

8. The hand-held device according to claim 1, characterized in that the handle element is hinged to the basic support element and preferably can be locked in position.

9. The hand-held device according to claim 1, characterized in that the handle element is arranged on the basic support element in a rigid but detachable fashion.

10. The hand-held device according to claim 1, characterized in that the basic support element is provided with a marginal bristle element on the opposite side referred to the handle element.

11. A basic support element for a hand-held device according to claim 1, consisting of a shell-shaped body for receiving the surfaces that face away from one another and a handle elements that is rigidly arranged on the basic support element.

12. Cleaning surfaces for a hand-held device according to claim 1, consisting of two congruent surfaces that are connected to one another in a pocket-like fashion on their edges, wherein an opening is provided for inserting the basic support element.
